(19) United States
(12) Patent Application Publication
(10) Pub. No.: US 2020/0037571 A1
(43) Pub. Date: Feb. 6, 2020

(54) Pet Toilet Device

(71) Applicant: Tzu-Chun Hu, Taoyuan City (TW)

(72) Inventor: Tzu-Chun Hu, Taoyuan City (TW)

(21) Appl. No.: 16/529,799

(22) Filed: Aug. 2, 2019

(30) Foreign Application Priority Data
Aug. 2, 2018 (TW) 107126952

(51) Int. Cl. A01K 1/01; A01K 15/02

(52) U.S. Cl. CPC A01K 1/0107; A01K 15/02

(57) ABSTRACT

A pet toilet device, especially suitable for cats, includes a toilet body, a resilient stopper and an excrement collection drawer. The toilet body has a channel and an accommodating space both arranged therein. The excrement collection drawer is provided in the accommodating space of the toilet body, positioned under the opening of the channel, and capable of being drawn out from the accommodating space. Hence, it allows cats to toilet by itself without cat litter. It is able to not only block the smell, but also save the spending of the cat owners from buying cat litter.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a technology of pet toilet device, and more particularly to a toilet device for cats, which allows a cat to toilet by itself without using cat litter, is capable of blocking the smell, and allows the user to clean up the excrement fast and easily.

### Description of Related Arts

The trend of keeping pets becomes more and more popular because of the declining of birth rate and increasing of celibacy and DINKs populations. Both single and married families keep pets to enliven their lives. Besides, studies also indicate that accompanying of pets helps their owners to be healthier mentally and physically. Among all the pets, cats and dogs are the most popular pets for the owners. Cats are independent, so even if the owners go out for work or getaway, cats can still live at home alone and independently without relying on special accompanying or caring of designated person.

The most important things of keeping cats are providing food and excretion place. Conventional cat litter box is a square shaped cat litter box. It has to put cat litter in the cat litter box and place the cat litter box at a regular place, so that when the cat feels like to litter box, it will go to the cat litter box by itself to urinate or defecate. Unfortunately, conventional cat litter is indecomposable and insoluble, which is therefore very environmental unfriendly. The consumption of cat litter is huge and cat litter usually has to be replaced daily in order to avoid smell. As a result, using cat litter in the long run becomes an economy burden for the owners.

Besides, conventional cat litter box usually has an open structure to contain the cat litter in a litter box. When the cat litter with urine and faeces has been placed in the owner's house for a while, the house will smell like cat's urine and faeces interiorly, which lowers the indoor air quality and affects the quality of life of the owner relatively.

Hence, the present invention aims to disclose a way to develop a pet toilet device that allows trained cats to toilet by themselves without requiring the cat owners to purchase cat litter, generally saving $3000-4000 NTD each year, while the device also isolates the urine and faeces to avoid smell even for a long time, which is generally more useful and convenient by not only creating clean toileting for the cats but also lowering the efforts and costs for the owners.

### SUMMARY OF THE PRESENT INVENTION

An object of the present invention is to provide a pet toilet device, which allows pet owners to train their cats to toilet by themselves without buying and cleaning cat litter, is capable of separating urine and faeces so as to avoid smell from diffusing in the house, and allows the pet owners to clean up the excrement fast and easily and to save the cost from buying cat litter, which is more economic and environmental friendly so as for better overall utility and convenience.

In order to achieve the above and other objects, the present invention provides a pet toilet device, which includes a toilet body, a resilient stopper and an excrement collection drawer. The toilet body has a channel and an accommodating space arranged therein. The accommodating space is arranged below and communicated with the channel. The toilet body also has a flip cover arranged on the surface thereof. The flip cover has a through hole arranged in the middle thereof. The through hole is communicated with the channel. The channel has an opening on the bottom thereof. The resilient stopper is arranged below the channel so as to resiliently block and open the opening on the bottom of the channel. The resilient stopper is connected with the flip cover. The excrement collection drawer is provided in the accommodating space of the toilet body, positioned under the opening of the channel, and capable of being drawn out from the accommodating space.

According to a preferred embodiment, the toilet body further includes a step arranged thereon, so as for the pet to climb up onto the flip cover of the toilet body. It can load water or aqueous solution in the excrement collection drawer. There is a connecting bar connected between the flip cover and the resilient stopper. The flip cover is connected with the connecting bar through a resilient element arranged below it.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a pet toilet device according to a preferred embodiment of the present invention.

FIG. 2 is a perspective view of the pet toilet device according to the above preferred embodiment of the present invention, illustrating an excrement collection drawer thereof being opened.

FIG. 3 is a perspective view illustrating an application scenario of the pet toilet device according to the above preferred embodiment of the present invention.

FIG. 4 is a perspective view illustrating an application scenario of a training box utilized along with the pet toilet device according to the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

The following is disclosed with specific embodiments to illustrate implementations of the present invention in order that person skilled in the art can understand the functions and other advantages of the present invention easily.

The appended drawings are utilized as reference to illustrate the embodiments of the present invention. However, it should be noted that the drawings are simplified perspective figures for illustrating basic concepts of the present invention only. Hence, it only demonstrates relative structures of the present invention, rather than reveals the specific quantities, shapes, and sizes of the elements of the actual implementations. It is worth mentioning that the forms, quantities, and ratios of the elements of the actual implementations of the present invention may change based on actual needs and shall not be limited by the drawings.

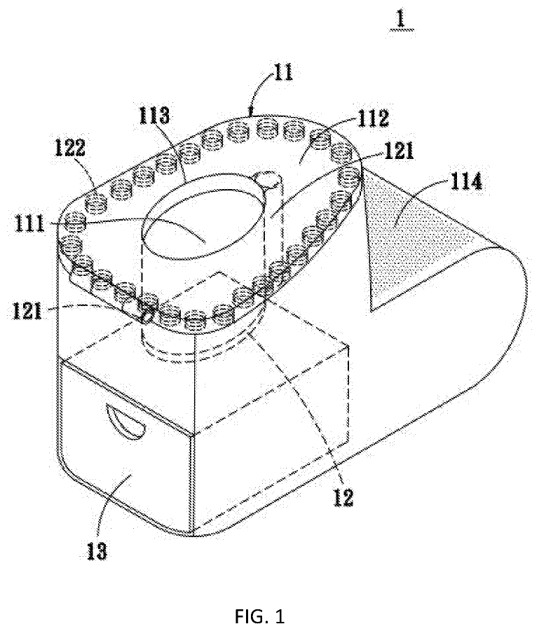

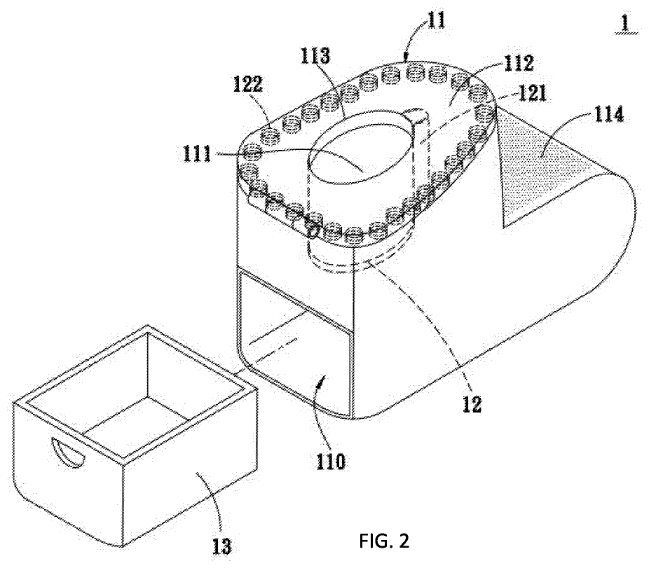

Referring to FIGS. 1 and 2, perspective views of a pet toilet device according to a preferred embodiment are illustrated, while the excrement collection drawer thereof is closed and opened respectively. Referring to the drawings, the present invention provides a pet toilet device 1, which is especially suitable for cats, including a toilet body 11, a resilient stopper 12, and an excrement collection drawer 13. The toilet body 11 has a channel 111 and an accommodating space 110 both arranged therein. The accommodating space 110 is arranged below and communicated with the channel 111. The toilet body 11 also has a flip cover 112 arranged on the surface thereof. The flip cover 112 has a through hole 113 arranged in the middle thereof. The through hole 113 is communicated with the channel 111. The channel 111 has an opening in the bottom thereof. The resilient stopper 12 is arranged below the channel 111 so as to resiliently block and open the opening at the bottom of the channel 111. The resilient stopper 12 is connected with the flip cover 112. The excrement collection drawer 13 is provided in the accommodating space 110 of the toilet body 11, positioned under the opening of the channel 111, and capable of being drawn out from the accommodating space 110.

According to a preferred embodiment, the toilet body 11 further includes a step 114 arranged thereon, so as for the pet to climb up onto the flip cover 112 of the toilet body 11. It can load water or aqueous solution in the excrement collection drawer 13. There is a connecting bar 121 connected between the flip cover 112 and the resilient stopper 12. The flip cover 112 is connected with the connecting bar 121 through a resilient element 122 arranged below it.

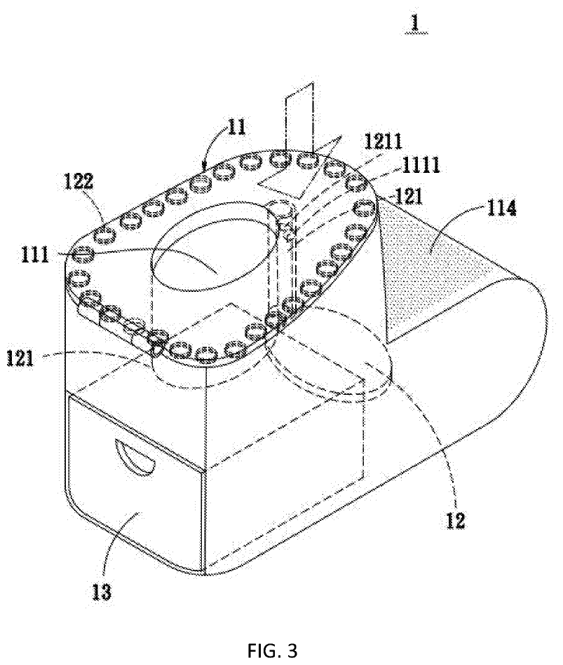

Referring to FIG. 3, an application scenario of the pet toilet device according to the above preferred embodiment of the present invention is illustrated. Firstly, water or aqueous solution is placed in the excrement collection drawer 13 when the device is utilized. When the cat feels like to toilet, it can climb up to the flip cover 112 of the toilet body 11 through the step 114, and then the flip cover 112 is pressed down due to the weight of the cat, such that the resilient element 122 generates a pressing resilience force to turn the resilient stopper 12 to a side. Because a ball track 1211 is arranged on the connecting bar 121 and a ball transfer unit 1111 is arranged in the side of the channel 111 at the position corresponding to the ball track 1211 of the connecting bar 121, when the flip cover 112 is pressed down to press the connecting bar 121, the ball track 1211 of the connecting bar 121 and the ball transfer unit 1111 at the outside affixing end are coordinated to slide downward and sideward to open the opening below the channel 111. As long as the cat keeps standing (or squat) on the flip cover 112, the opening below the channel 111 stays opened, so as to allow the excrement to successfully falling into the excrement collection drawer 13 via the channel 111 and to be dissolved in the water. When the cat leaves the flip cover 112, the resilient element 122 springbacks so as to return the resilient stopper 12 to its original position and close the opening below the channel 111, that can actually seal the smell and block its diffusion so as to avoid the smell of the excrement from spreading to the house via the channel 111. The water or aqueous solution in the excrement collection drawer 13 can also soften the excrement, so as to allow the sewage in the excrement collection drawer 13 to be cleaned by dumping into a regular domestic toilet directly without blocking the toilet.

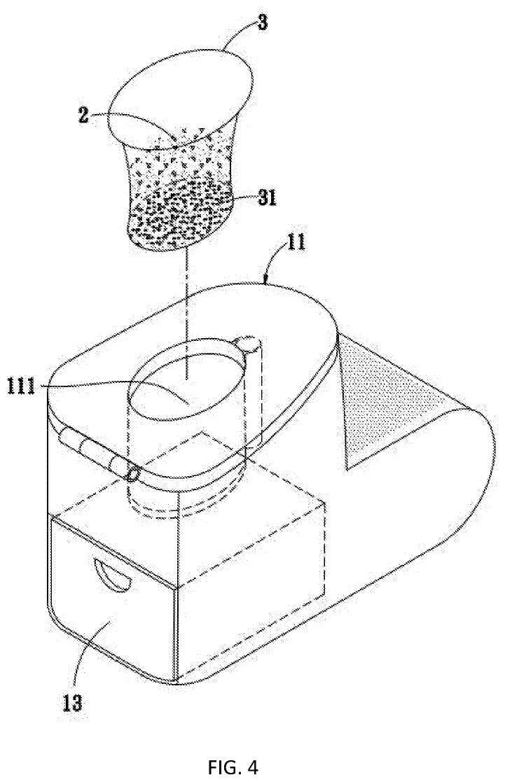

Referring to FIG. 4, an application scenario of a training box utilized along with the pet toilet device according to the present invention is illustrated. The present invention utilizes cat's nature of covering odors to induce it to use the present invention. However, it may also apply the following training steps before the actual utilization. The first step is to place the cat litter 2 that the cat has been used to utilize in a training box 3. A plurality of fine holes 31 is provided in the bottom of the training box 3. The size of each of the fine holes 31 must be smaller than the cat litter, so as to only allow the urine to flow into the excrement collection drawer 13 through the fine holes 31. Then, the training box 3 may be placed at the hatch of the channel 111 of the toilet body 11, so as to help the cat to get used to the toileting circumstances. It has to keep the cat litter 2 in the training box clean and there must be sufficient cat litter 2 for covering up of the cat to during this training stage. The second step is to observe if the cat becomes used to or adapted to the device rather than randomly relieve itself. If the cat can utilize the pet toilet device of the present invention successfully in this stage, it may start to consider reducing the amount of the cat litter 2 from the training box 3. The last step is to remove the training box 3 when the cat gets used to toilet on the present invention, so as to normally utilize the present invention.

By means of the above construction, pet owner does not have to utilize cat litter box and cat litter as the cat toilet device, which saves the monthly spending of cat litter and the daily effort of changing cat litter, avoids excrement smell from diffusing in the house, and makes cleaning of the excrement easier and faster.

Contrasting to the art, the pet toilet device provided by the present invention mainly allows the owner to train his/her cat to toilet by itself without utilizing cat litter box and cat litter, isolates excrement automatically to avoid the smell from diffusing in the house, and utilizes water or aqueous solution to soften the excrement for being simply dumped into regular domestic toilet, which makes the cleaning easier and faster, more economic, and more environmental friendly so as to improve the overall utility and convenience thereof.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A pet toilet device, comprising:
a toilet body having a channel and an accommodating space therein and comprising a flip cover arranged on a surface thereof, wherein said channel has an opening in a bottom thereof and said accommodating space is arranged below and communicated with said channel, wherein said flip cover has a through hole arranged in a middle thereof and communicated with said channel;
a resilient stopper which is connected with said flip cover and arranged below said channel to resiliently block and open said opening at said bottom of said channel; and
an excrement collection drawer provided in said accommodating space of said toilet body and positioned under said opening of said channel, wherein said excrement collection drawer is removable from said accommodating space.

2. The pet toilet device, as recited in claim 1, wherein said toilet body further comprises a step arranged thereon adapted for a pet to climb up onto said flip cover of said toilet body.

3. The pet toilet device, as recited in claim 1, wherein said excrement collection drawer is arranged for allowing water or aqueous solution to be loaded therein.

4. The pet toilet device, as recited in claim 1, wherein said resilient stopper further comprises a connecting bar connected between said flip cover and said resilient stopper, wherein said flip cover is connected with said connecting bar through a resilient element arranged therebelow.
